(19) United States
(12) Patent Application Publication
(10) Pub. No.: US 2021/0043881 A1
(43) Pub. Date: Feb. 11, 2021

(54) BATTERY CELL INSULATION AND WETTABILITY

(71) Applicant: Apple Inc., Cupertino, CA (US)

(72) Inventors: Dapeng Wang, San Jose, CA (US); Sang Young Yoon, San Jose, CA (US); Jinjun Shi, San Jose, CA (US)

(73) Assignee: Apple Inc., Cupertino, CA (US)

(21) Appl. No.: 16/983,428

(22) Filed: Aug. 3, 2020

Related U.S. Application Data
(60) Provisional application No. 62/884,042, filed on Aug. 7, 2019.

(51) Int. Cl. H01M 2/02; H01M 10/0587

(52) U.S. Cl. CPC H01M 2/0267; H01M 2220/30; H01M 10/0587; H01M 2/026

(57) ABSTRACT

Batteries according to embodiments of the present technology may include an enclosure. The batteries may include an electrode stack including a separator positioned between an anode and a cathode. The electrode stack may be characterized by a first side from which a plurality of electrode tabs extend, a second side opposite the first, a third side, and a fourth side opposite the third. The batteries may also include a wrapping seated on a first surface of the electrode stack and extending beyond an edge of each of the second, the third, and the fourth sides of the electrode stack a distance equal to or greater than a thickness of the electrode stack. The wrapping may be adhered to a second surface of the electrode stack opposite the first surface of the electrode stack on each of the second side, the third side, and the fourth side of the electrode stack.

### CROSS-REFERENCES TO RELATED APPLICATIONS

The present application claims the benefit of priority to U.S. Provisional Application No. 62/884,042, filed Aug. 7, 2019, the contents of which are hereby incorporated by reference in their entirety for all purposes.

### TECHNICAL FIELD

The present technology relates to batteries. More specifically, the present technology relates to battery insulation and component configurations.

### BACKGROUND

Batteries are used in many devices. As battery enclosures are modified for various reasons, the enclosure materials may impact battery cell materials and designs.

### SUMMARY

Batteries according to embodiments of the present technology may include an enclosure. The batteries may include an electrode stack including a separator material positioned between an anode and a cathode. The electrode stack may be characterized by a first side from which a plurality of electrode tabs extend, a second side opposite the first side, a third side, and a fourth side opposite the third side. The batteries may also include a wrapping seated on a first surface of the electrode stack and extending beyond an edge of each of the second side, the third side, and the fourth side of the electrode stack a distance equal to or greater than a thickness of the electrode stack. The wrapping may be adhered to a second surface of the electrode stack opposite the first surface of the electrode stack on each of the second side, the third side, and the fourth side of the electrode stack.

In some embodiments, the wrapping and the separator material may be or include similar materials. The wrapping may be characterized by a thickness greater than a thickness of the separator material. The batteries may include electrolyte at least partially absorbed within the wrapping. The wrapping may further extend beyond an edge of the first side of the electrode stack from which the plurality of electrode tabs extend. The wrapping may include a section of the wrapping extending beyond the edge of the first side of the electrode stack characterized by a width less than or equal to a distance between a first electrode tab and a second electrode tab of the plurality of electrode tabs. The enclosure may include a conductive enclosure maintained at an electrical potential of the anode. The electrode stack may include a wound configuration, and an exterior of the wound configuration may include anode current collector material. The electrode stack may include a plurality of stacked layers of each of the anode, the cathode, and the separator material. The plurality of stacked layers may include individual layers of anode material and cathode material, and each individual layer may be characterized by a current collector having electrode active material disposed on two opposing surfaces of the current collector. The batteries may include an additional anode layer positioned on an exterior of the wrapping. The additional anode layer may include an anode current collector having active material disposed on a single surface of the anode current collector, and the single surface may face the wrapping.

Some embodiments of the present technology may encompass batteries, which may include a conductive enclosure. The batteries may include an electrode stack including an anode, a cathode, and a separator positioned between the anode and the cathode. The anode and the cathode may include conductive tabs extending from a first end of the electrode stack, and the conductive enclosure may be maintained at an operating potential of the anode. The batteries may include a wrapping extending about an exterior of the electrode stack. The batteries may include electrolyte incorporated with the electrode stack and the wrapping.

In some embodiments, the wrapping may encase all exterior surface of the electrode stack but for a surface of the first end of the electrode stack. The anode and the cathode may each include a current collector having electrode active material on a first surface of the current collector and on a second surface of the current collector opposite the first surface of the current collector. The anode and the cathode may be wound about one another from a proximal end of each of the anode and the cathode to a distal end of each of the anode and the cathode. A distal end of the anode may be characterized by anode active material on only the first surface of the current collector, and the second surface of the current collector may form an exterior surface of the electrode stack. The wrapping may include a material similar to the separator of the electrode stack.

Some embodiments of the present technology may encompass batteries including a metal enclosure. The metal enclosure may house an electrode stack including an anode, a cathode, and a separator positioned between the anode and the cathode. The anode and the cathode may include conductive tabs extending from a first end of the electrode stack. The anode may be coupled to the metal enclosure. The batteries may include a wrapping including a material similar to the separator, and the wrapping may be coupled about an exterior surface of the electrode stack. The batteries may also include an electrolyte material. In some embodiments the electrode stack may include a plurality of stacked layers of each of the anode, the cathode, and the separator. The plurality of stacked layers may include individual layers of anode material and cathode material, and each individual layer may be characterized by a current collector having electrode active material disposed on two opposing surfaces of the current collector.

Such technology may provide numerous benefits over conventional technology. For example, the present batteries may be characterized by increased electrical insulation for battery cells. Additionally, the batteries may be characterized by better wetting to produce improved electrolyte distribution within a cell. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic cross-sectional view of a battery cell according to some embodiments of the present technology.

FIG. 2 shows a schematic front elevation view of a battery according to some embodiments of the present technology.

FIG. 3 shows a schematic cross-sectional side elevation view of a battery according to some embodiments of the present technology.

FIG. 4A shows a schematic top plan view of battery materials according to some embodiments of the present technology.

FIG. 4B shows a schematic side elevation view of battery materials according to some embodiments of the present technology.

FIG. 4C shows a schematic side elevation view of battery materials according to some embodiments of the present technology.

FIG. 4D shows a schematic front elevation view of battery materials according to some embodiments of the present technology.

FIG. 5A shows a schematic side elevation view of battery materials according to some embodiments of the present technology.

FIG. 5B shows a schematic partial front elevation view of battery materials according to some embodiments of the present technology.

FIG. 5C shows a schematic partial front elevation view of battery materials according to some embodiments of the present technology.

FIG. 5D shows a schematic top plan view of battery materials according to some embodiments of the present technology.

Several of the figures are included as schematics. It is to be understood that the figures are for illustrative purposes, and are not to be considered of scale or proportion unless specifically stated to be of scale or proportion. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Batteries, battery cells, and more generally energy storage devices, are used in a host of different systems. In many devices, the battery cells may be designed with a balance of characteristics in mind. For example, including larger batteries may provide increased usage between charges, however, the larger batteries may require larger housing, or increased space within the device. As device designs and configurations change, especially in efforts to reduce device sizes, the available space for additional battery components may be constrained. These constraints may include restrictions in available volume as well as the geometry of such a volume.

Some battery enclosure materials may afford reduced production tolerances, which may allow an increase in the size of battery cell components within the enclosure. Conventional devices that have or include conductive enclosures may be characterized by a risk of electrical shorting between the enclosure and materials of the battery cell. The present technology may overcome these issues, however, by providing a configuration by which battery cell components may include improved insulation, which may additionally improve electrolyte wetting of the internal cell. After illustrating an exemplary cell that may be used in embodiments of the present technology, the present disclosure will describe battery designs having a cell wrapping for use in a variety of devices in which battery cells may be used.

Although the remaining portions of the description will reference lithium-ion batteries, it will be readily understood by the skilled artisan that the technology is not so limited. The present techniques may be employed with any number of battery or energy storage devices, including other rechargeable and primary battery types, as well as secondary batteries, or electrochemical capacitors. Moreover, the present technology may be applicable to batteries and energy storage devices used in any number of technologies that may include, without limitation, phones and mobile devices, watches, glasses, bracelets, anklets, and other wearable technology including fitness devices, handheld electronic devices, laptops and other computers, as well as other devices that may benefit from the use of the variously described battery technology.

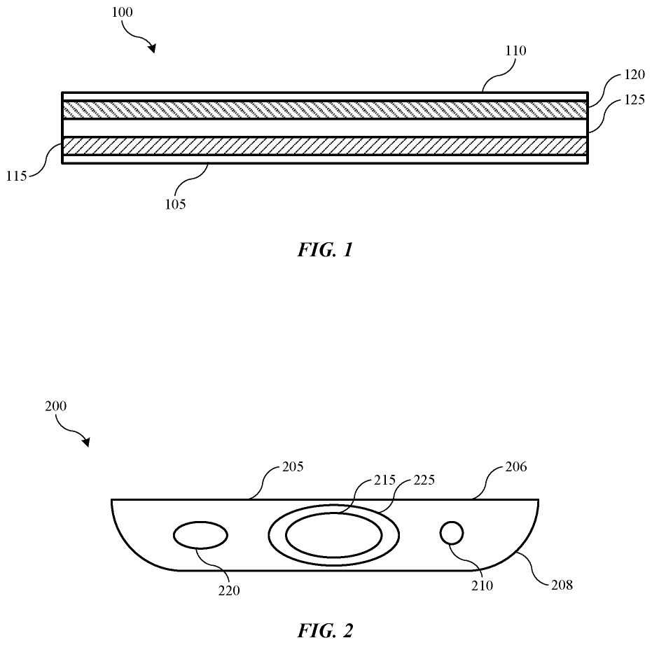

FIG. 1 depicts a schematic cross-sectional view of an energy storage device or battery cell 100 according to embodiments of the present technology. Battery cell 100 may be or include a battery cell, and may be one of a number of cells coupled together to form a battery structure. As would be readily understood, the layers are not shown at any particular scale, and are intended merely to show the possible layers of cell material of one or more cells that may be incorporated into an energy storage device. In some embodiments, as shown in FIG. 1, battery cell 100 includes a first current collector 105 and a second current collector 110. In embodiments one or both of the current collectors may include a metal or a non-metal material, such as a polymer or composite that may include a conductive material. The first current collector 105 and second current collector 110 may be different materials in embodiments. For example, in some embodiments the first current collector 105 may be a material selected based on the potential of an anode active material 115, and may be or include copper, stainless steel, or any other suitable metal, as well as a non-metal material including a polymer. The second current collector 110 may be a material selected based on the potential of a cathode active material 120, and may be or include aluminum, stainless steel, or other suitable metals, as well as a non-metal material including a polymer. In other words, the materials for the first and second current collectors can be selected based on electrochemical compatibility with the anode and cathode active materials used, and may be any material known to be compatible.

In some instances the metals or non-metals used in the first and second current collectors may be the same or different. The materials selected for the anode and cathode active materials may be any suitable battery materials operable in rechargeable as well as primary battery designs. For example, the anode active material 115 may be silicon, silicon oxide, silicon alloy, graphite, carbon, a tin alloy, lithium metal, a lithium-containing material, such as lithium titanium oxide (LTO), a combination of any of these materials, or other suitable materials that can form an anode in a battery cell. Additionally, for example, the cathode active material 120 may be a lithium-containing material. In some embodiments, the lithium-containing material may be a lithium metal oxide, such as lithium cobalt oxide, lithium manganese oxide, lithium nickel manganese cobalt oxide, lithium nickel cobalt aluminum oxide, lithium nickel cobalt manganese oxide, lithium nickel cobalt aluminum oxide, lithium titanate, or a combination of any of these materials, while in other embodiments the lithium-containing material can be a lithium iron phosphate, or other suitable materials that can form a cathode in a battery cell.

The first and second current collectors as well as the active materials may have any suitable thickness. A separator 125 may be disposed between the electrodes, and may be a polymer film, a ceramic membrance, or a material that may allow lithium ions to pass through the structure while not otherwise conducting electricity. Active materials 115 and 120 may additionally include an amount of electrolyte in a completed cell configuration, which may be absorbed within the separator 125 as well. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example.

In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities, such as greater than or about 5⁻¹⁰ mS/cm.

Although illustrated as single layers of electrode material, battery cell 100 may be any number of layers. Although the cell may be composed of one layer each of anode and cathode material as sheets, the layers may also be formed into a jelly roll design, or folded design, prismatic design, or any form such that any number of layers may be included in battery cell 100. For embodiments which include multiple layers, tab portions of each anode current collector may be coupled together, as may be tab portions of each cathode current collector. Once the cell has been formed, a pouch, housing, or enclosure may be formed about the cell to contain electrolyte and other materials within the cell structure, as will be described below. Terminals may extend from or be coupled with the enclosure to allow electrical coupling of the cell for use in devices, including an anode and cathode terminal. The coupling may be directly connected with a load that may utilize the power, and in some embodiments the battery cell may be coupled with a control module that may monitor and control charging and discharging of the battery cell. FIG. 1 is included as an exemplary cell that may be incorporated in batteries according to the present technology. It is to be understood, however, that any number of battery and battery cell designs and materials that may include charging and discharging capabilities similarly may be encompassed by or incorporated with the present technology.

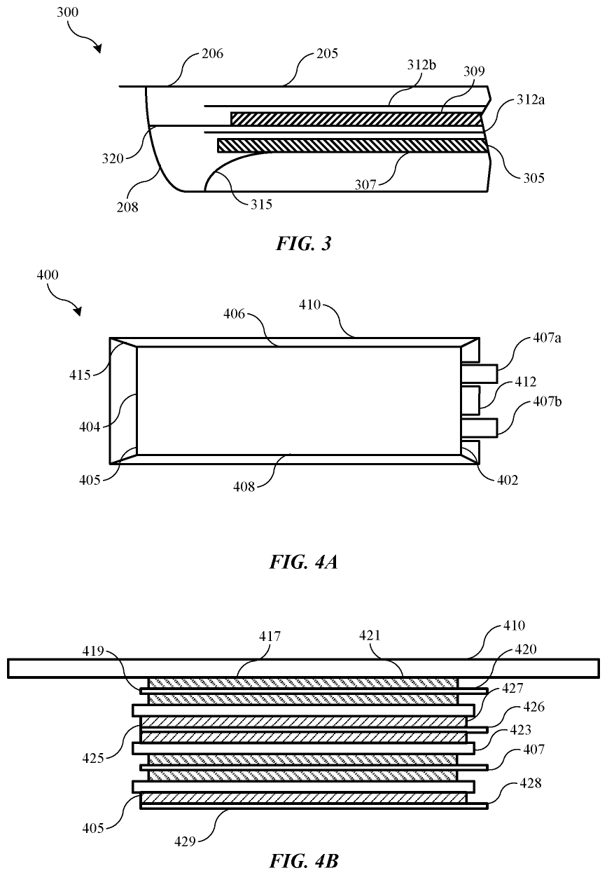

FIG. 2 shows a schematic plan view of a battery 200 according to some embodiments of the present technology. As illustrated, battery 200 may include a housing or enclosure 205, which may include any number of battery cells, including cells as previously described, incorporated within the enclosure. Enclosure 205 may include a rigid housing, and may include a conductive housing, such as stainless steel, or any other metal or conductive material. The conductive housing may be maintained at positive or negative potential in embodiments, and may be maintained at negative potential, which may then operate as a device ground, and be considered similar to a neutral connection within a device incorporating the battery. Additionally, by using a rigid housing instead of a flexible pouch, fabrication tolerances on the battery dimensions may be reduced, which may afford increased volume for the internal battery cells, which may provide increased capacity over conventional designs. The rigid housing or can may include a lid 206 enclosure for the rest of the housing, which may include a base 208 defining an internal volume in which cell materials are incorporated. The lid 206 and base 208 may include a seamless or substantially seamless form providing an internal volume in which the battery cell or cells and electrolyte may be contained.

Battery 200 may include one or more terminals extending from battery enclosure 205 and providing electrical access to the battery cell. Additionally, a port 210 may be positioned along a surface of the enclosure as illustrated. Port 210 may be a fill port or other access to battery 200, and may be sealed in embodiments. Port 210 may be positioned proximate a lateral edge of battery 200 and may be used as an injection location for electrolyte to fill battery 200 and form a functioning cell.

A first electrode terminal 215 and a second electrode terminal 220 may extend from or be accessible along a surface, such as a front surface of battery enclosure 205. In some embodiments, each of the first electrode terminal and the second electrode terminal may extend from the surface of battery enclosure 205 a similar distance. In some embodiments, first electrode terminal 215 may extend outward from the surface further than second electrode terminal 220. As previously noted, in some embodiments the enclosure 205 of battery 200 may be conductive and may be at the potential of one of the electrodes, such as the anode, although the housing may also be maintained at cathode potential. The second electrode terminal 220 may represent the electrode terminal of the potential at which the housing is maintained. Accordingly, the terminal may be a contact, tab, or access of the housing. The first electrode terminal 215, however, may be at the opposite potential of the housing and/or the second electrode terminal 220, and may be maintained or electrically isolated from the rest of the housing. For example, first electrode terminal 215 may be the cathode terminal, although the terminal may also be maintained at anode potential in other embodiments.

To isolate the first electrode terminal 215 from the rest of the housing, a spacer 225 may extend circumferentially about the first electrode terminal, and extend through the housing of battery enclosure 205. In some embodiments, spacer 225 may fully isolate first electrode terminal 215 from the battery enclosure 205 both internally and externally to avoid a potential short between the housing, which may be at anode potential, and first electrode terminal 215, which may be at cathode potential.

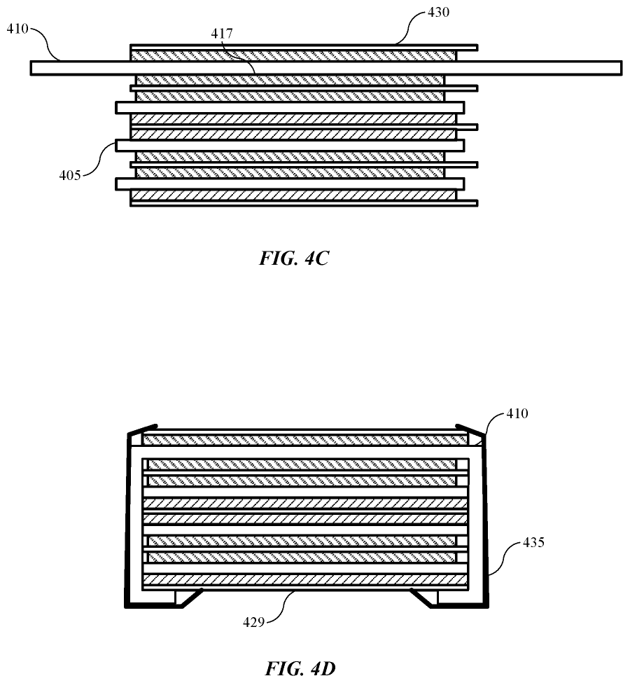

Turning to FIG. 3 is illustrated a schematic cross-sectional side elevation view of a battery 300 according to some embodiments of the present technology. Battery 300 may be a partial cross-section through battery 200 in some embodiments, which may allow further explanation of the materials and connection of components within the enclosure. Accordingly, similar numbering may be used from battery 200, although the figures may illustrate alternative and/or additional features. As noted previously, battery enclosure 205 may be conductive, and may be a metal enclosure having a lid 206 and a base 208 forming a volume in which a battery cell 305 may be included. Battery cell material 305 is merely illustrative of materials that may be included in a number of different forms or geometries, which will be described in further detail below, and thus, the illustration is not intended to limit the present disclosure.

Battery cell material 305 may include an electrode stack including an anode 307 and a cathode 309, with a separator 312 positioned between the electrodes. Separator 312a is illustrated between the components, and an additional separator 312b may optionally be included in some embodiments to further maintain cathode 309 electrically isolated from anode 307 as well as enclosure 205. A tab or conductive extension 315 may extend from anode 307, such as a tab from a current collector, and may electrically couple anode 307, which may include a number of stacked anodes, with enclosure 205. Similarly, a tab or conductive extension 320 may extend from cathode 309 in a similar fashion, and may electrically couple cathode 309, which may include a number of stacked cathodes, with first electrode terminal 215 described previously, and which may limit or prevent electrical coupling with enclosure 205. As noted above, FIG. 3 is included as a schematic representation of coupling encompassed by the present technology, and is included merely to illustrate coupling that may be performed for any of the embodiments described, and is not intended to limit the disclosure.

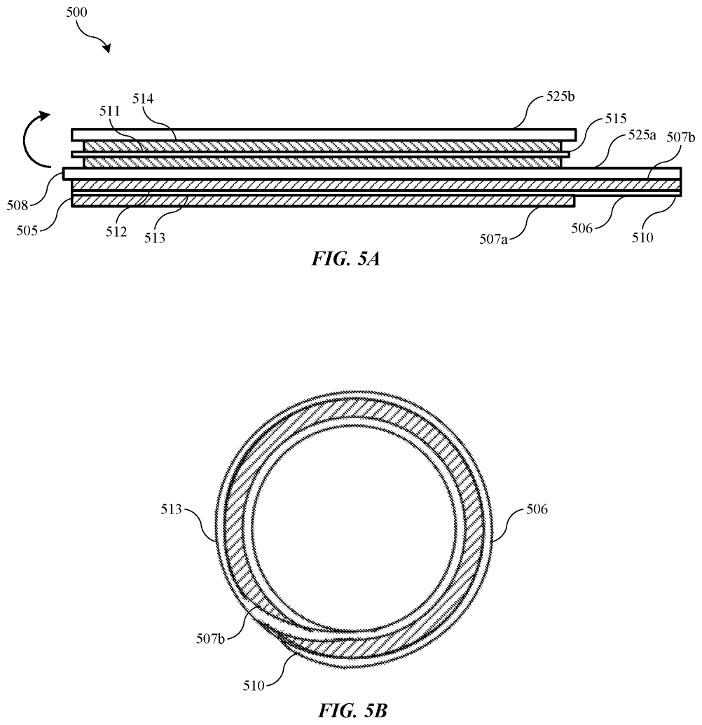

FIG. 4A shows a schematic top plan view of battery cell materials 400 according to some embodiments of the present technology. Battery cell materials 400 may include any of the materials or configurations described previously. Battery cell materials 400 may include an electrode stack 405, which may include a separator material positioned between an anode and a cathode, as described above, for example, and may include a number of anode and cathode layers in a stack. Electrode stack 405 may be characterized by a first side 402, a second side 404 opposite first side 402, a third side 406 extending between the first side 402 and the second side 404, and a fourth side 408 opposite third side 406. One or more electrode tabs 407 may extend from the electrode stack 405 on first side 402.

Battery cell materials 400 may also include a wrapping 410 positioned or seated on electrode stack 405. Wrapping 410 may extend beyond exterior edges of the electrode stack 405 on one or more sides, up to all four sides noted previously. For example, wrapping 410 may extend beyond a lateral edge of the electrode stack on each of the second side, the third side, and the fourth side. The amount of extension may be related to the thickness of the electrode stack in some embodiments. For example, once folded about the electrode stack, the wrapping 410 may extend beyond an outermost lateral edge along a height of the electrode stack on each side a distance greater than or equal to a thickness of the electrode stack. Wrapping 410 may be extended along a thickness of the stack to enclose or encase the electrode stack along a thickness of the electrode stack on each side of the electrode stack. This may provide a layer of insulation, which may further protect against contact between cathode materials or anode materials with the enclosure in which the battery cell materials 400 are disposed.

Wrapping 410 may include one or more slits 415 or cuts through the wrapping, which may facilitate bending and adhering the wrapping along a height or thickness of the electrode stack. The slits 415 may be incorporated at each corner of the wrapping, and may extend a distance towards the electrode stack. Although illustrated as angled slits, it is to be understood that slits 415 may include straight cuts as well, which may also facilitate folding the material to ensure coverage about the electrode stack.

First side 402 of the electrode stack may have one or more electrode tabs extending from the electrode stack, with the number of tabs depending on the number of layers in the stack, for example. The tabs may interfere with wrapping 410 in some embodiments, which may be adjusted to accommodate the first side 402, when the first side includes wrapping. For example, in some embodiments an insulative cap, gasket, or tape may be positioned against the first side of the electrode stack while wrapping 410 extends about the other sides as noted. When wrapping 410 is included extending past an edge of the first side 402 of the electrode stack, the wrapping 410 may only extend in sections adjacent the position of electrode tabs as illustrated. The wrapping 410 may include a section 412 extending past the first side, and section 412 may be characterized by a width as shown that may be less than, equal to, or greater than a distance between a first electrode tab 407a and a second electrode tab 407b. The electrode tabs 407 may be multiple electrode tabs coupled together to electrically group anode and cathode materials throughout the electrode stack in some embodiments, and section 412 of wrapping 410 may extend between the anode and cathode electrode tabs, for example. Additional sections may also be included as illustrated that are located laterally outward from the electrode tabs 407 and extending towards the corners of the first side of the electrode stack.

FIG. 4B shows a schematic side elevation view of battery materials 400 according to some embodiments of the present technology. It is to be understood that the figure illustrates an example arrangement encompassed by the present technology, but is not intended to limit the scope of the present technology. FIG. 4B may illustrate the electrode materials 400 during formation or fabrication of the battery prior to being incorporated within a metal or conductive enclosure as described previously. As described above, battery materials 400 may include an electrode stack 405 and a wrapping 410, although the figure may also illustrate a cross-sectional view of a wound electrode stack. Wrapping 410 may be seated on a first surface 417 of electrode stack 405 during fabrication, and may extend beyond sides of the electrode stack as previously discussed.

The illustrations of FIGS. 4A-4D represent some embodiments encompassed by the present technology, and which show a stack of electrode layers. As will be discussed further below, the present technology may also be adapted to other battery configurations, and is not intended to be limited to any particular battery configuration. As shown, electrode stack 405 may include a plurality of stacked layers including individual layers of anode materials and cathode material. Although only two layers of each material are illustrated, it is to be understood that any number of layers of materials may be included in embodiments of the present technology, which is not limited to any number of stack layers.

The layers of anode and cathode may include current collectors coated with electrode active material on one or both sides of the current collector. As noted above, one exemplary enclosure may be maintained at anode potential, and FIG. 4B may be illustrated for such an exemplary arrangement. Where the enclosure is maintained at cathode potential, it is to be understood that the anode and cathode layers may be reversed from the explained series here.

A layer of the electrode stack defining the first surface 417 of the electrode stack on which the wrapping 410 is disposed may be a cathode 419. Cathode 419, and any number of other cathode layers including all interior cathode layers, may include a cathode current collector 420 as previously described having layers of cathode active material 421 disposed on opposing surfaces of the cathode current collector. Separators 423 may be positioned between cathode layers and anode layers to prevent electrical contact between the materials. Alternating with the cathode materials may be anode 425. Anode 425 may include an anode current collector 426 as previously described having layers of anode active material 427 disposed on opposing surfaces of the anode current collector. The figure may illustrate electrode tabs 407 extending from each current collector of the stack. Electrode tabs 407 may be portions or extensions of the current collectors themselves, or may be additional conductive elements coupled with the current collectors.

This pattern of cathode, separator, and anode layers may be repeated for any number of cell units down to abase electrode 428, which may be an anode. Because this outer layer may be in contact or proximate the enclosure, in embodiments the material may be the material at a similar electrical potential as the enclosure. As noted previously, when the enclosure is maintained at cathode potential, the layers may be reversed from the order described. Base electrode 428 may also include an anode current collector 426, although anode active material 427 may only be disposed on a single side of the current collector as illustrated. The other side of the current collector on base electrode 428 may define a second surface 429 of electrode stack 405, with which wrapping 410 may be coupled as will be described further below. Additionally of note is that for each layer, separator 423 may extend laterally beyond the lateral length of anode active materials 427, which in turn may extend laterally beyond the lateral length of cathode active materials 421. Separator 423 may be a flexible material, and when wrapping 410 is extended along the sides of the electrode stack, separator 423 may be further folded about the active materials, which may provide additional assurance against exposure of the cathode active materials, which may be characterized by the least lateral extension of the cell.

FIG. 4C shows a schematic side elevation view of battery materials 400 according to some embodiments of the present technology, and may illustrate a subsequent fabrication operation from the stack illustrated in FIG. 4B. As illustrated, an additional electrode 430 may be positioned on an exterior of wrapping 410. Additional electrode 430 may also be an anode layer, and similar to base electrode 428, may include an anode current collector with anode active material disposed only on a single surface of the current collector. As shown, the active material may be disposed on the surface of the current collector facing the wrapping 410 and electrode stack 405. Hence, wrapping 410 may be seated on a first surface 417 of electrode stack 405, and may be disposed between the electrode stack 405 and an additional electrode 430, which may be an additional functioning electrode of the battery cell being produced. As will be explained below, this may be facilitated by wrapping 410 being a similar material as the separators 423 disposed throughout the electrode stack.

FIG. 4D shows a schematic front elevation view of battery materials 400 according to some embodiments of the present technology, such as an elevation view of first side 402 of the electrode stack. The figure may illustrate a completed battery cell stack that may be disposed within an enclosure as previously described, such as with FIG. 3. Although not illustrated, the electrode tabs 407 of each electrode may be joined with electrode tabs of similar materials. For example, each of the anode electrode tabs may be coupled together, and each of the cathode electrode tabs may be coupled together to produce single anode and cathode couplings that may be electrically coupled with the enclosure or first electrode terminal of the enclosure.

The wrapping 410 may be extended down along the sides of the electrode stack, which may provide insulation along each of the cathode layers to limit or prevent any openings through which direct contact may occur between the cathode materials and the enclosure in which the battery materials 400 may be disposed. The wrapping 410 may fully encase or enclose the electrode stack on all exterior surfaces, or less than all surfaces, such as all surfaces but for the surface from which electrode tabs extend. Depending on the amount of overhang of the wrapping 410, the wrapping may extend partially along second surface 429 of the electrode stack. A tape 435 or adhesive may be positioned to couple the wrapping 410 with the second surface 429 of the electrode stack. The tape may be include at a number of locations about the periphery of the battery materials to ensure coverage is complete about the electrode stack. Once formed, the completed battery materials may be disposed in an enclosure and electrolyte may be incorporated within the electrode stack and the wrapping.

Tapes may be used with batteries to protect exposed surfaces, although the tapes in conventional technologies may provide a barrier for electrolyte incorporation. As explained above, once the completed battery cell materials are positioned within the enclosure and the enclosure is sealed, electrolyte may be injected into the enclosure at a single location. The electrolyte must then be absorbed throughout the entire battery cell stack. Tapes may provide additional barriers to incorporation of the electrolyte, which may facilitate dry spots where active materials may not be wetted with electrolyte. Accordingly, by including wrapping 410 according to embodiments of the present technology, less or no tape that may limit electrolyte incorporation may be used because the wrapping 410 may provide a consistent insulative layer about the electrode stack and cathode materials, or materials at the opposite potential from which the enclosure is maintained. Moreover, because of the properties of the wrapping material, additional benefits may be afforded.

As noted above, wrapping 410 may be the same or a similar material as separator materials included within the electrode stack. Consequently, wrapping 410 may at least partially absorb electrolyte injected within the enclosure, and may facilitate wetting by absorbing and distributing the electrolyte more evenly around the stack. Indeed, areas of the wrapping 410 over which tape or adhesive may be disposed may not be impacted by the tape as the wrapping 410 may continue to spread electrolyte across these areas through the wrapping. The wrapping may also operate as a reservoir of additional electrolyte to further limit or prevent the formation of dry spots within the active material. Accordingly, in some embodiments, wrappings according to the present technology may improve wetting of battery cell materials within the electrode stack.

Wrappings according to embodiments of the present technology may be any of the materials noted for separators, and in some embodiments may be an additional layer of separator material that is wrapped about lateral sides along a thickness of the electrode stack. In some embodiments the wrapping may be characterized by a thickness that is about the same, less than, or greater than the thickness of the separator materials incorporated within the electrode stack. The wrapping may be a polymeric material in some embodiments, and may be the same polymeric material as the separator, for example.

In some embodiments, the polymer is a polymeric hydrocarbon, which may include substituted hydrocarbons or functionalized polymers. In some examples, the polymer is a polyolefin, and may be or include polymers such as polyethylene, polypropylene, and other hydrocarbon-based polymers. The materials may include combinations of materials, such as polyethylene-polypropylene. Suitable materials may also include functional moieties including esters, aromatics, acetals, and other known functional groups. The materials may include thermoplastic materials, including polyethylene terephthalate or polyoxymethylene, and the materials may also include grafted polymers including polyethylenes with grafted materials such as siloxanes or methacrylates. In some embodiments the separators may also include one or more materials such as adhesive binders and ceramic materials. Incorporating a ceramic material into the separator or wrapping structure may afford dimensional stability, improved wetting, as well as reduced thermal shrinkage. When incorporated as a particulate material, ceramics may include a platelet structure.

Tape 435 may be used in some embodiments, and may include an adhesive, such as an adhesive applied on a surface of a polymeric material to form the tape. Additionally, in some embodiments adhesive may be applied on a portion of the wrapping 410, such as on an exterior portion that may constitute a region to be coupled with second surface 429, such as in a window frame type of coverage, for example, although in other embodiments adhesive may be applied in a more uniform pattern along the surface of the wrapping in contact with the electrode stack. Exemplary adhesives may include a variety of adhesive materials that may couple or bond with electrode active materials, current collector materials, and separator materials. Adhesive materials may improve adhesion between separators and electrodes, and hence stack stiffness. Suitable adhesives may include multiple adhesive materials including polymeric materials.

Exemplary polymeric materials include materials including acetate, acrylate, vinyl groups, styrene, or any other materials that may be utilized according to the present technology. For example, exemplary adhesives may include acrylate and/or polyvinylidene fluoride (“PVDF”), including poly(vinylidene fluoride-co-hexafluoropropylene), the morphology of which may be controlled to limit reductions in porosity.

Discontinuous coatings may be formed in any number of ways to further limit an impact of the adhesive on operation of the wrapping as a separator layer, such as with various coating techniques. Additionally, loading of the adhesive, or the amount of adhesive deposited, may be adjusted to create more of a patched distribution of adhesive, which may produce a non-uniform coating affording increased porosity and permeability. When applied only to external portions of the wrapping that may be coupled with the second surface of the electrode stack, the adhesive may pose less of an impact on operation of the wrapping as a separator material, as the wrapping may operate as a separator on more interior regions of the wrapping, such as those regions in direct contact with electrode active materials.

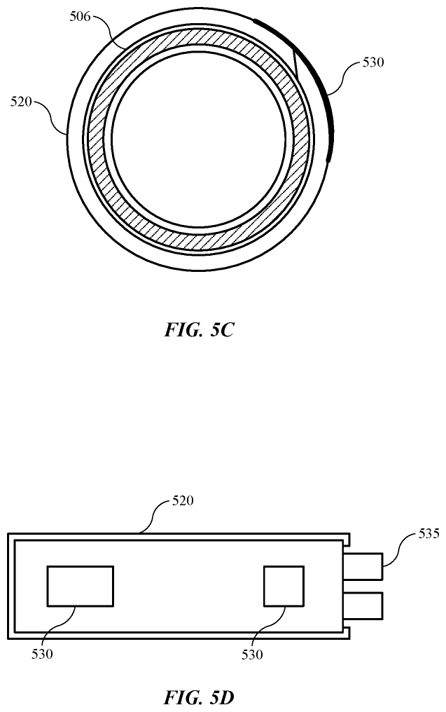

As noted above, the present technology is not limited to any particular electrode configuration. The previous figures were based on a set of stacked electrodes, although the present technology is equally applicable to any battery configuration, including wound cells, such as jelly rolls or prismatic cells. FIG. 5A shows a schematic side elevation view of battery materials 500 according to some embodiments of the present technology. Battery materials 500 may include an electrode stack that may be overlapped in one or more ways to produce a wound battery configuration. The produced wound cell may be incorporated in a conductive enclosure similar to the enclosures described above. Any of the materials, components, or characteristics described above may be equally applied to battery materials 500.

Battery materials 500 may include an anode 505 and a cathode 515, with a separator 525 positioned between the electrodes. Separator 525a may be positioned between the two electrodes, while second separator 525b may be positioned on an opposite surface of the cathode 515 from a surface in contact with separator 525a. Similar to the previous example, anode 505 may include a current collector 506 having anode active material 507 disposed on opposing sides of the current collector. Additionally, cathode 515 may include a current collector 511 having cathode active material 514 disposed on opposing sides of the current collector. Cathode 515 may have similar coating on each side of the current collector, however in some embodiments as illustrated, anode 505 may have dissimilar coating on the current collector.

For example, battery materials 500 may be characterized by a proximal end 508 and a distal end 510 in a direction of overlap, where the interior of the winding may be proximal end 508, while an outermost layer of the formed cell may be distal end 510. Anode current collector 506 may be characterized by a first surface 512, which may be a surface facing separator 525 and cathode 515. Anode current collector 506 may also be characterized by a second surface 513 opposite the first surface 512. First surface 512 may include anode active material 507b extending substantially along the first surface 512, and may cover a majority portion of the surface towards the distal end 510 of battery materials 500. Of course, sections for electrode tabs or other tolerances may exist and the figure is not to be considered of scale.

On second surface 513, anode active material 507a may not fully extend to distal end 510, which may leave a portion of anode current collector 506 exposed at the distal end. The amount of exposure may be equal to or about a distance of circumference of the completed wound cell, which may produce a cell where an outermost exterior surface is anode current collector material, and not anode active material, about the last complete turn of the wound cell. Battery materials 500 may then be wound in the direction of the arrow from proximal end 508 to distal end 510 to produce a wound or folded structure. By maintaining a distance of the second surface of the current collector uncoated, where the distance is about a length of the last full turn of the wound cell, an exterior surface of the completed cell may be anode current collector. Similar to the examples above, where an enclosure in which the battery materials are disposed is to be maintained at cathode potential, the layers may be reversed so that an exterior layer may be cathode current collector material.

FIG. 5B shows a schematic partial front elevation view of battery materials 500 according to some embodiments of the present technology, and may illustrate the battery materials 500 subsequent winding. FIG. 5B does not show the full winding configuration, but schematically illustrates an exterior of the winding illustrating the final exterior turn of the winding. It is intended that one of skill can readily appreciate the layers of the wound cell after folding or winding as illustrated in FIG. 5A has been performed. The figure illustrates that the distance of current collector 506 that is not coated on second surface 513 forms the final turn of the winding so anode active material may not be exposed on the exterior of the wound battery materials. It is to be understood that while the figure illustrates a generally cylindrical cell, the materials similarly encompass additional cell designs, such as prismatic or flattened, wound configurations.

FIG. 5C shows a schematic partial front elevation view of battery materials 500 according to some embodiments of the present technology, and may illustrate the battery materials after a wrapping 520 is positioned about the cell. Again, the figure is not shown to scale and merely is intended to show that the wrapping 520 may extend about an exposed anode current collector material 506, which may be the outermost layer of the winding, and the exposed exterior surface on which wrapping 520 may be disposed. One or more sections of tape 530 or adhesive may be included to conform the wrapping to the shape of the electrode stack. Any of the wrapping, electrode, or adhesive materials described above are applicable to the illustrated configuration.

FIG. 5D shows a schematic plan view of battery materials 500 according to some embodiments of the present technology. As shown, the wrapping 520 may extend across some or all of the exterior surfaces of the wound cell. The cell may include electrode tabs 535 extending from a first end of the cell, and wrapping 520 may fully encase all other surfaces of the cell, including a second end of the cell opposite the first, and sections of tape 530 may facilitate maintaining the wrapping in contact with the electrode stack about the surfaces, which may be at least partially curved. In some embodiments, wrapping 520 may also cover the first end of the cell by extending about the electrode tabs. In some embodiments a cap, gasket, insulation, or tape may be applied over the first end as described previously. Wrapping 520 may insulate the second end, which may otherwise include open access to cathode active materials, despite the overhang of anode active materials and separator providing a recessed coverage for the cathode active materials. By using wrapping according to the present technology, improved electrical insulation may be afforded. Exemplary wrapping may similarly provide improved distribution of electrolyte once battery materials 500 are inserted within an enclosure, and electrolyte is injected, as explained above, as well as an additional reservoir of electrolyte that may be used by the battery cell materials during operation.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A battery comprising:
an enclosure;
an electrode stack comprising a separator material positioned between an anode and a cathode, wherein the electrode stack is characterized by a first side from which a plurality of electrode tabs extend, a second side opposite the first side, a third side, and a fourth side opposite the third side; and
a wrapping seated on a first surface of the electrode stack and extending beyond an edge of each of the second side, the third side, and the fourth side of the electrode stack a distance equal to or greater than a thickness of the electrode stack, wherein the wrapping is adhered to a second surface of the electrode stack opposite the first surface of the electrode stack on each of the second side, the third side, and the fourth side of the electrode stack.

2. The battery of claim 1, wherein the wrapping and the separator material comprise similar materials.

3. The battery of claim 2, wherein the wrapping is characterized by a thickness greater than a thickness of the separator material.

4. The battery of claim 1, further comprising electrolyte at least partially absorbed within the wrapping.

5. The battery of claim 1, wherein the wrapping further extends beyond an edge of the first side of the electrode stack from which the plurality of electrode tabs extend.

6. The battery of claim 5, wherein the wrapping comprises a section of the wrapping extending beyond the edge of the first side of the electrode stack characterized by a width less than or equal to a distance between a first electrode tab and a second electrode tab of the plurality of electrode tabs.

7. The battery of claim 1, wherein the enclosure comprises a conductive enclosure maintained at an electrical potential of the anode.

8. The battery of claim 1, wherein the electrode stack comprises a wound configuration, and wherein an exterior of the wound configuration comprises anode current collector material.

9. The battery of claim 1, wherein the electrode stack comprises a plurality of stacked layers of each of the anode, the cathode, and the separator material.

10. The battery of claim 9, wherein the plurality of stacked layers comprise individual layers of anode material and cathode material, each individual layer characterized by a current collector having electrode active material disposed on two opposing surfaces of the current collector.

11. The battery of claim 10, further comprising an additional anode layer positioned on an exterior of the wrapping.

12. The battery of claim 11, wherein the additional anode layer comprises an anode current collector having active material disposed on a single surface of the anode current collector, the single surface facing the wrapping.

13. A battery comprising:
a conductive enclosure;
an electrode stack comprising an anode, a cathode, and a separator positioned between the anode and the cathode, wherein the anode and the cathode include conductive tabs extending from a first end of the electrode stack, and wherein the conductive enclosure is maintained at an operating potential of the anode;
a wrapping extending about an exterior of the electrode stack; and
electrolyte incorporated with the electrode stack and the wrapping.

14. The battery of claim 13, wherein the wrapping encases all exterior surface of the electrode stack but for a surface of the first end of the electrode stack.

15. The battery of claim 13, wherein the anode and the cathode each comprise a current collector having electrode active material on a first surface of the current collector and on a second surface of the current collector opposite the first surface of the current collector.

16. The battery of claim 15, wherein the anode and the cathode are wound about one another from a proximal end of each of the anode and the cathode to a distal end of each of the anode and the cathode.

17. The battery of claim 16, wherein a distal end of the anode is characterized by anode active material on only the first surface of the current collector, and wherein the second surface of the current collector forms an exterior surface of the electrode stack.

18. The battery of claim 13, wherein the wrapping comprises a material similar to the separator of the electrode stack.

19. A battery comprising:
a metal enclosure, the metal enclosure housing:
an electrode stack comprising an anode, a cathode, and a separator positioned between the anode and the cathode, wherein the anode and the cathode include conductive tabs extending from a first end of the electrode stack, and wherein the anode is coupled to the metal enclosure;
a wrapping comprising a material similar to the separator, the wrapping coupled about an exterior surface of the electrode stack; and
an electrolyte material.

20. The battery of claim 19, wherein the electrode stack comprises a plurality of stacked layers of each of the anode, the cathode, and the separator, and wherein the plurality of stacked layers comprise individual layers of anode material and cathode material, each individual layer characterized by a current collector having electrode active material disposed on two opposing surfaces of the current collector.
